(19) United States
(12) Patent Application Publication
(10) Pub. No.: US 2019/0015798 A1
(43) Pub. Date: Jan. 17, 2019

(54) ORGANIC FERTILIZER MIXING DEVICE

(71) Applicant: Te-Yung CHANG, Nantou County (TW)

(72) Inventor: Te-Yung CHANG, Nantou County (TW)

(21) Appl. No.: 15/890,542

(22) Filed: Feb. 7, 2018

(30) Foreign Application Priority Data
Jul. 12, 2017 (TW) 106210253

(51) Int. Cl. B01F 7/00; B01F 15/06; B01F 15/00; C05F 9/02

(52) U.S. Cl. CPC B01F 7/00641; B01F 15/065; B01F 15/00396; B01F 7/00616; B01F 2215/0054; B01F 7/00341; C05F 9/02; B01F 2015/062; B01F 7/00275

(57) ABSTRACT

An organic fertilizer mixing device includes a container having an upper surface thereof formed as an opening. The container is provided therein with a rotation shaft, of which two ends are positioned on a left support member and a right support member outside the container, respectively. One end of the rotation shaft is connected to a driving member that drives the rotation shaft to rotate in place in the container. The rotation shaft in the container is connected to a propelling mixing blade assembly that synchronously rotates with the rotation shaft. Most part of a lower portion of the container is attached with a heating unit that fully increases the temperature at an inner side of the lower portion of the container, thus accelerating, while the propelling blade assembly mixes kitchen waste such as fruit and vegetable waste, the speed for fermenting and converting the kitchen waste to organic fertilizer.

### BACKGROUND OF THE INVENTION

### Field of the Invention

The present invention relates to an organic fertilizer mixing device, and more particularly, to a device capable of accelerating speed for fermenting and converting kitchen waste such as fruit and vegetable waste to organic fertilizer.

### Description of the Related Art

A current common mixing device primarily includes a container having a top side thereof as an open form, a mixing shaft provided in the container, and a driving mechanism fixedly provided outside the container. The driving mechanism is driven by a motor to cause the mixing shaft to rotate in its place. The mixing shaft is provided with several diverging mixing sticks extended from an outer peripheral surface thereof towards different directions. The mixing sticks stir and mix in the container along with the in-place rotation of the mixing shaft to mix various raw materials and evenly blend the raw materials in the container. After the mixing operation is completed, the container is inverted to have the open top side of the container be inclined and face downwards so as remove the mixed raw materials.

With respect to kitchen waste such as fruit and vegetable waste, such kitchen waste needs to be left still for an extended period of time after the above mixing process in order to become organic fertilizer. Further, it is discovered during the actual mixing process that, although the materials are thoroughly blended after the mixing and stirring by the mixing sticks, and operating staff is able to remove the mixture from the mixing sticks after the container is tilted and inverted. However, the mixed materials are evenly accumulated in the container, and thus operating staff is required to extend both hands using large-scale motion among the mixing sticks in order to remove the mixed materials, which decreases efficiency while increases the danger of accidentally touching the mixing sticks.

### SUMMARY OF THE INVENTION

In view of the above, the Applicant provides, based on experience and continuous research, development and improvement, a technical scheme distinguishing from the prior art so as to improve the technical problem of the prior art.

It is an object of the present invention to provide an organic fertilizer mixing device for solving the technical problem of the prior art, in which a conventional mixing device only performs mixing on kitchen waste such as fruit and vegetable waste in a way that the mixed kitchen waste needs to be left still for an extended period of time before the mixed kitchen waste can be fermented into organic fertilizer. In the present invention, heating is simultaneously performed during the mixing process and enzyme that may be used is added, thus accelerating the speed for fermenting kitchen waste such as fruit and vegetable waste.

It is another object of the present invention to provide an organic fertilizer mixing device for resolving technical problem of a conventional mixing device, the efficiency for removing mixed materials of which is less satisfactory and which is more dangerous, thereby facilitating operations, effectively enhancing the effectiveness in removing materials and reducing operation dangers.

To achieve the above objects, an organic fertilizer mixing device provided by the present invention includes a container, a rotation shaft, a left support member, a right support member, a propelling mixing blade assembly and a heating unit. An upper surface of the container is formed as an opening. The rotation shaft is provided in the container, and two ends thereof respectively are positioned on a left support member and a right support member outside the container. One end of the rotation shaft is connected to a driving member that drives the rotation shaft to rotate in its place in the container. The propelling blade assembly is connected to the rotation shaft in the container and rotates synchronously with the rotation shaft. The heating unit is attached to most part of a bottom of the container to fully increase the temperature at an inner side of the bottom of the container.

In implementation, the rotation shaft rotates in its place in a direction from a top end of the container toward a front end of the container. At least one material exit port is provided at a central position of the front end of the container, and at least one movable door is provided on the at least one material exit port for having the at least one material exit port covered or uncovered.

In implementation, the propelling mixing blade assembly includes a propelling blade assembly and a mixing blade assembly for propelling and mixing a material in the container.

In implementation, the propelling blade assembly includes a central propelling rod, a first left propelling rod, a second left propelling rod, a first right propelling rod and a second right propelling rod. The central propelling rod has one end thereof connected axially to a central position of the rotation shaft in the container, and another end thereof provided with a central pushing portion. The first left propelling rod has one end thereof connected on the rotation shaft at the left side of and spaced from the central propelling rod in a direction away from the central propelling rod, and another end thereof provided with a first left pushing portion. The second left propelling rod has one end thereof connected on the rotation shaft at the left side of and spaced from the first left propelling rod in a direction away from the first left propelling rod, and another end thereof provided with at least one second left pushing portion. The first right propelling rod has one end thereof connected on the rotation shaft at the right side of and spaced from the central propelling rod in a direction away from the central propelling rod, and another end thereof provided with a first right pushing portion. The second right propelling rod has one end thereof connected on the rotation shaft at right side of and spaced from the first right propelling rod in a direction away from the first right propelling rod, and another end thereof provided with at least one second right pushing portion. The central propelling rod, the first left propelling rod, the second left propelling rod, the first right propelling rod and the second right propelling rod are bent and extended outwardly from the rotation shaft in a direction reverse to a rotation direction of the rotation shaft.

In implementation, the mixing blade assembly includes a first left blade assembly, a second left blade assembly, a fifth left cutting blade, a first right blade assembly, a second right blade assembly and a fifth right cutting blade. The first left blade assembly includes a first left cutting blade and a second left cutting blade. One end of the first left cutting blade and another end of the second left cutting blade are respectively connected on the rotation shaft between the central propelling rod and the first left propelling rod. Another end of the first left cutting blade is provided with a first left deflected portion deflecting leftward, and another end of the second left cutting blade is provided with a second right deflected portion deflecting rightward. The second left blade assembly includes a third left cutting blade and a fourth left cutting blade. One end of the third left cutting blade and one end of the fourth left cutting blade are respectively connected on the rotation shaft between the first left propelling rod and the second left propelling rod. Another end of the third left cutting blade is provided with a third left deflected portion deflecting leftward, and another end of the fourth left cutting blade is provided with a fourth right deflected portion deflecting rightward. One end of the fifth left cutting blade is connected on the rotation shaft, and a connection end of the second left propelling rod and the rotation shaft and this end of the fifth left cutting blade form an obtuse angle. Another end of the fifth left cutting blade is provided with a fifth right deflected portion deflecting rightward. The first right blade assembly includes a first right cutting blade and a second right cutting blade. One end of the first right cutting blade and one end of the second right cutting blade are respectively connected on the rotation shaft between the central propelling rod and the first right propelling rod. Another end of the first right cutting blade is provided with a first left deflected portion deflecting leftward, and another end of the second right cutting blade is provided with a second right deflected portion deflecting rightward. The second right blade assembly includes a third right cutting blade and a fourth right cutting blade. One end of the third right cutting blade and one end of the fourth right cutting blade are respectively connected on the rotation shaft between the first right propelling rod and the second right propelling rod. Another end of the third right cutting blade is provided with a third left deflected portion deflecting leftward, and another end of the fourth right cutting blade is provided with a fourth right deflected portion deflecting rightward. One end of the fifth right cutting blade is connected on the rotation shaft, and a connecting end of the second right propelling rod and the rotation shaft and this end of the fifth right cutting blade form an obtuse angle. Another end of the fifth right cutting blade is provided with a fifth left deflected portion deflecting leftward. The first left cutting blade, the second left cutting blade, the third left cutting blade, a fourth left cutting blade, the fifth left cutting blade, the first right cutting blade, the second right cutting blade, the third right cutting blade, the fourth right cutting blade and the fifth right cutting blade are respectively bent and extended outwardly from the rotation shaft in a direction reverse to the rotation direction of the rotation shaft.

In implementation, the heating unit is electrically connected to a control unit that controls a heating temperature of the heating unit.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a perspective view showing a preferred embodiment of the present invention;

FIG. 2 to FIG. 5 are planar schematic diagrams of different implementation forms of a heating unit according to preferred embodiments of the present invention;

FIG. 6 is a perspective view showing a propelling blade assembly and a mixing blade assembly respectively installed on a rotation shaft according to a preferred embodiment of the present invention; and

FIG. 7 is a schematic diagram showing the use of a preferred embodiment of the present invention.

### DETAILED DESCRIPTION OF THE INVENTION

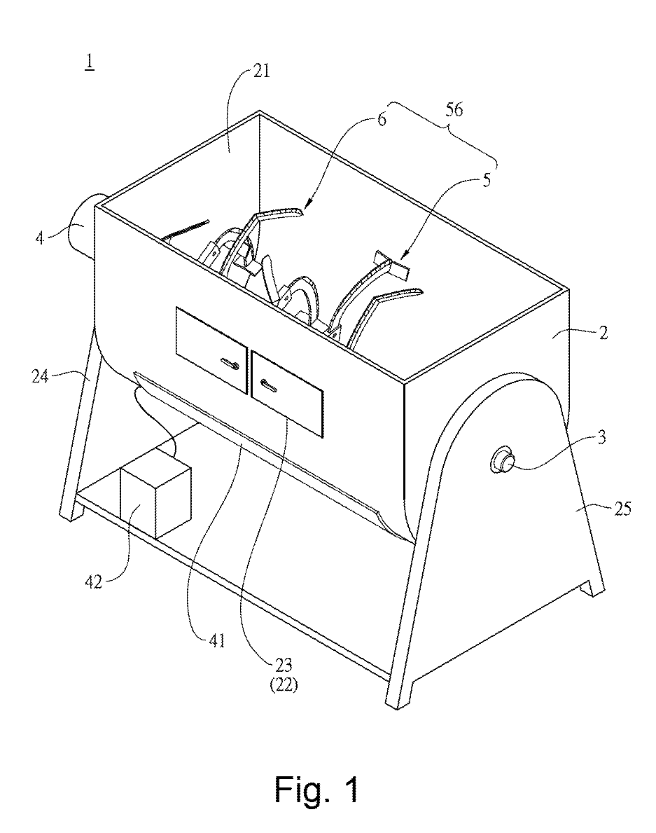

FIG. 1 shows an organic fertilizer mixing device 1 according to a preferred embodiment of the present invention. Referring to FIG. 1, the organic fertilizer mixing device 1 primarily includes a container 2, a rotation shaft 3, a driving member 4, a heating unit 41, and a propelling mixing blade assembly 56. The container 2 is a rectangular metal frame having a bottom thereof formed as a downwardly recessed hemisphere. In this embodiment, one end facing and close to a user is defined as a front end, and one end opposite to the front end and away from a user to is defined as a back end. When a user faces the front end of the container 2, a left side and a right side of the container 2 are accordingly defined. An upper surface of the container 2 forms an opening 21, which serves as an input end for a material. Two material exit ports 22 are provided at a central position of the front end of the container 2, and two movable doors 23 are provided on the two material exit ports 22 for having the two material exit ports 22 covered or uncovered, respectively. A left support member 24 and a right support member 25 are provided on two sides outside the container 2, respectively.

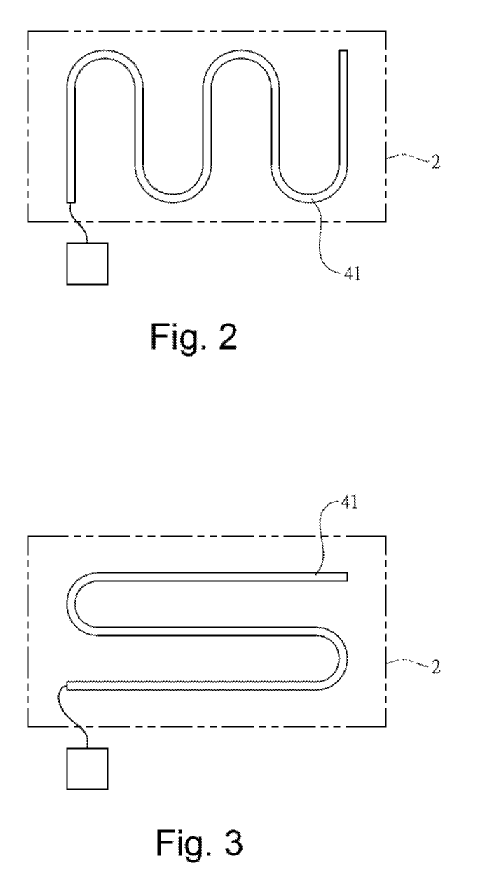

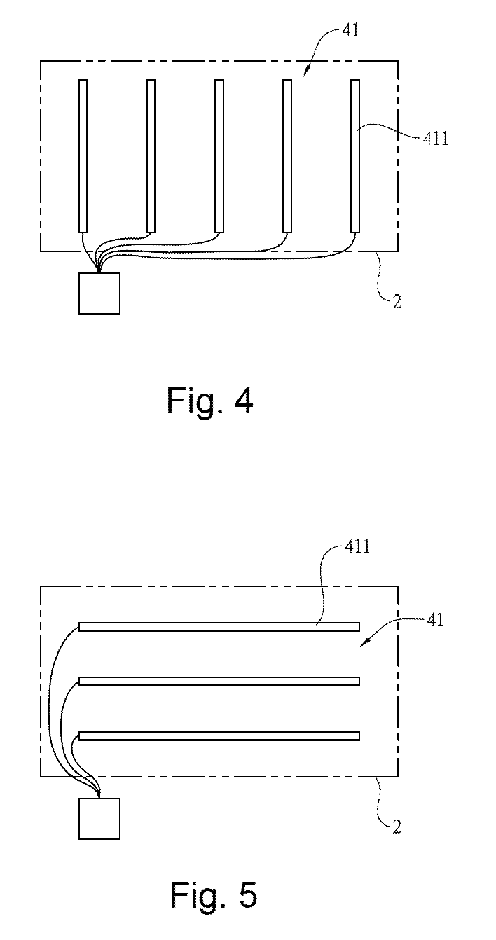

The rotation shaft 3 is traversely positioned in the container 2, and left and right ends thereof are pivotally connected on the left support member 24 and the right support member 25, respectively. The left end of the rotation shaft 3 protrudes from the left side of the container 2. The driving member 4 includes a motor and a deceleration mechanism. The deceleration mechanism is connected to the left end of the rotation shaft 3 and drives the rotation shaft 3, such that the rotation shaft 3 rotates in its place at a low speed in a direction from a top end of the container 2 towards the front end of the container 2. The heating unit 41 is formed as a long plate so as to be attached to most part of the bottom of the container 2. The heating unit 41 is electrically connected to a control unit 42 that controls a heating temperature of the heating unit 41, so as to fully increase the temperature at an inner side of the bottom of the container 2. In implementation, the heating unit 41 may also be attached to most part of the bottom of the container 2 in a continuous winding way, as shown in FIG. 2 and FIG. 3. Alternatively, the heating unit 41 may include a plurality of heating plates 411, which are spaced from each other and attached in parallel to most part of the bottom of the container 2.

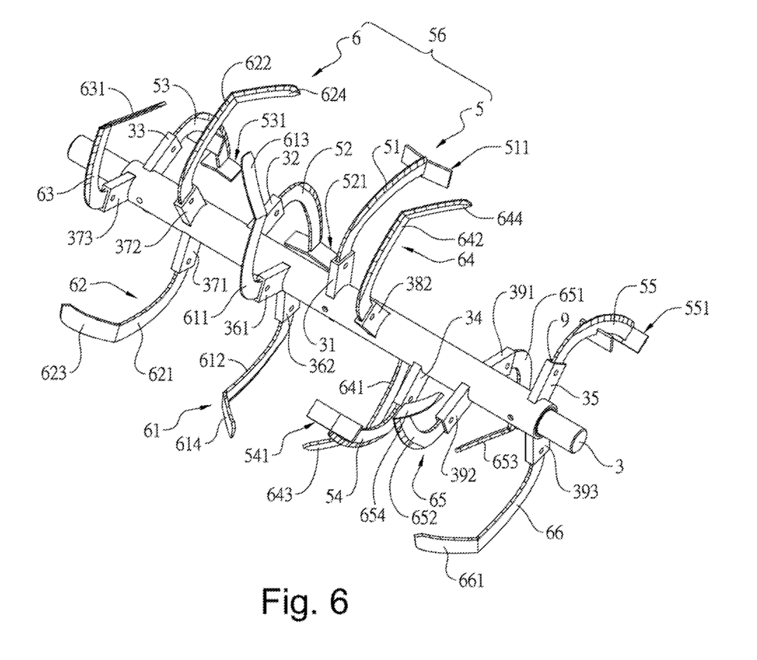

Referring to FIG. 6, a central positioning portion 31 is provided at an central of axial position of the rotation shaft 3, a first left positioning portion 32 and a second left positioning portion 33 are provided on the left side of and spaced from the central positioning portion 31 in an axial direction away from the central positioning portion 31, and a first right positioning portion 34 and a second right positioning portion 35 are provided on the right side of and spaced from the central positioning portion 31, in an axial direction away from the central positioning portion 31. The central positioning portion 31, the first left positioning portion 32, the second left positioning portion 33, the first right positioning portion 34 and the second right positioning portion 35 are respectively axially protruding, and each includes a positioning groove 9.

A first left connecting portion 361 and a second left connecting portion 362 forming as an obtuse angle and respectively axially protruding are provided on the rotation shaft 3 between the central positioning portion 31 and the first left positioning portion 32. A third left connecting portion 371 and a fourth left connecting portion 372 forming as an obtuse angle and respectively axially protruding are provided on the rotation shaft 3 between the first left positioning portion 32 and the second left positioning portion 33. A fifth left connecting portion 373 is further provided on the shaft 3, and the fifth left connecting portion 373 and the second left positioning portion 33 form an obtuse angle. A first right connecting portion 381 and a second right connecting portion 382 forming as an obtuse angle and respectively axially protruding are provided on the rotation shaft 3 between the central positioning portion 31 and the first right positioning portion 34. A third right connecting portion 391 and the fourth right connecting portion 392 forming as an obtuse angle and respectively axially protruding are provided on the rotation shaft 3 between the first right positioning portion 34 and the second right positioning portion 35. A fifth right connecting portion 393 is further provided on the rotation shaft 3, and the fifth right connecting portion 393 and the second right positioning portion 35 form an obtuse angle.

The propelling mixing blade assembly 56 includes a propelling blade assembly 5 and a mixing blade assembly 6. The propelling blade assembly 5 is connected on the rotation shaft 3 in the container 2 for synchronously rotating with the rotation shaft 3. The propelling blade assembly 5 includes a central propelling rod 51, a first left propelling rod 52, a second left propelling rod 53, a first right propelling rod 54 and a second right propelling rod 55, which are respectively bent and extended outwardly from the rotation shaft 3 in a direction reverse to a rotation direction of the rotation shaft 3. The central propelling rod 51 has one end thereof inserted and connected to the central positioning portion 31, and another end thereof provided with two plates each displaying an inclined angle relative to the central propelling rod 51, wherein the two plates form as a central pushing portion 511. The first left propelling rod 52 has one end thereof inserted and connected to the first left connecting portion 32, and another end thereof provided with two plates each forming an inclined angle relative to the first left propelling rod 52, wherein the two plates form as a first left pushing portion 521. The second left propelling rod 53 has one end thereof inserted and connected to the second left connecting portion 33, and a central position thereof and another end thereof respectively provided with two plates each forming an inclined angle relative to the second left propelling rod 53, wherein the four plates serve as a second left pushing portion 531.

The first right propelling rod 54 has one end thereof inserted and connected to the first right connecting portion 34, and another end thereof provided with two plates each forming an inclined angle relative to the first right propelling rod 54, wherein the two plates form as a first right pushing portion 541. The second right propelling rod 55 has one end thereof inserted and connected to the second right connecting portion 35, and a central position and another end thereof respectively are provided with two plates each displaying an inclined angle relative to the second right propelling rod 55, wherein the four plates serve as a second right pushing portion 551.

The mixing blade assembly 6 includes a first left blade assembly 61, a second left blade assembly 62, a fifth left cutting blade 63, a first right blade assembly 64, a second right blade assembly 65 and a fifth right cutting blade 66. The first left blade assembly 61 includes a first left cutting blade 611 and a second left cutting blade 612. One end of the first left cutting blade 611 and one end of the second left cutting blade 612 are respectively inserted and connected on the first left connecting portion 361 and the second left connecting portion 362. Another end of the first left cutting blade 611 is provided with a first left deflected portion 613 deflecting leftward, and another end of the second left cutting blade 612 is provided with a second right deflected portion 614 deflecting rightward. The second left blade assembly 62 includes a third left cutting blade 621 and a fourth left cutting blade 622. One end of the third left cutting blade 621 and one end of the fourth left cutting blade 622 are respectively inserted and connected on the third left connecting portion 371 and the fourth left connecting portion 372. Another end of the third left cutting blade 621 is provided with a third left deflected portion 623 deflecting leftward, and another end of the fourth left cutting blade 622 is provided with a fourth right deflected portion 624 deflecting rightward. The fifth left cutting blade 63 has one end thereof connected on the fifth left connecting portion 373, and another end thereof provided with a fifth right deflected portion 631 deflecting rightward.

The first right blade assembly 64 includes a first right cutting blade 641 and a second right cutting blade 642. One end of the first right cutting blade 641 and one end of the second right cutting blade 642 are respectively inserted and connected on the first right connecting portion 381 and the second right connecting portion 382. Another end of the first right cutting blade 641 is provided with a first left deflected portion 643 deflecting leftward, and another end of the second right cutting blade 642 is provided with a second right deflected portion 644 deflected rightward. The second right blade assembly 65 includes a third right cutting blade 651 and a fourth right cutting blade 652. One end of the third right cutting blade 651 and one end of the fourth right cutting blade 652 are respectively inserted and connected on the third right connecting portion 391 and the fourth right connecting portion 392. Another end of the third right cutting blade 651 is provided with a third left deflected portion 653 deflecting leftward, and another end of the fourth right cutting blade 652 is provided with a fourth right deflected portion 654 deflecting rightward. The fifth right cutting blade 66 has one end thereof connected on the fifth right connecting portion 393, and another end thereof provided with a fifth left deflected portion 661 deflecting leftward.

The first left cutting blade 611, the second left cutting blade 612, the third left cutting blade 621, the fourth left cutting blade 622, the fifth left cutting blade 63, the first right cutting blade 641, the second right cutting blade 642, the third right cutting blade 651, the fourth right cutting blade 652 and the fifth right cutting blade 66 are respectively bent and extended outwardly from the rotation shaft 3 in a direction reverse to the rotation direction of the rotation shaft 3.

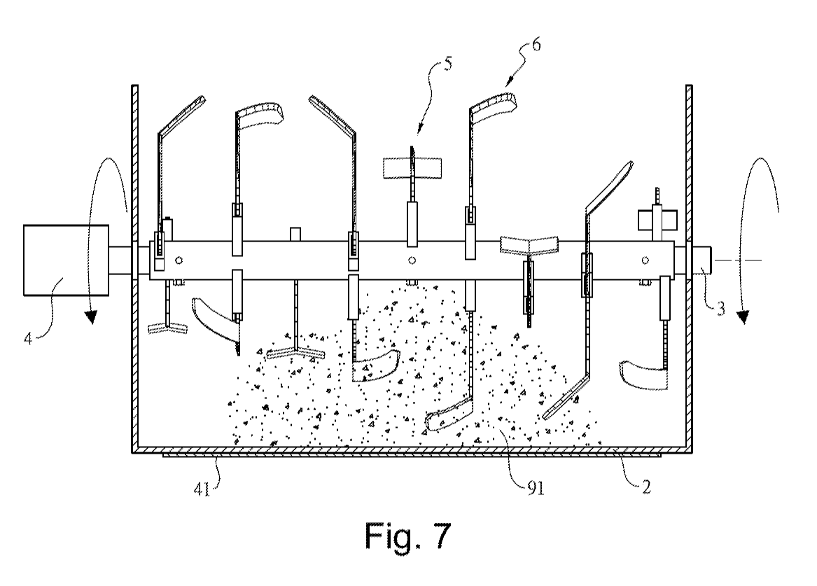

Thus, as shown in FIG. 7, when operating staff pours a kitchen waste mixed material 91 such as fruit and vegetable waste and enzyme that may be used into the container 2 and utilizes the driving member 4 to drive and rotate the rotation shaft 3 in its place, the propelling blade assembly 5 and the mixing blade assembly 6 can be positioned according to a predetermined arrangement and mix and propel the mixed material 91. During the mixing process, the heating unit 41 heats most part of the bottom of the container 2, thus accelerating the speed for fermenting the kitchen waste and allowing most of the kitchen waste mixed material 91 to remain at a central position of the container 2. As such, the operating staff can then remove the kitchen waste mixed material 91 from the two material exit ports 22 at the central position at the front end of the container 2, so as to enhance the effectiveness in removing the material.

Accordingly, the present invention has following advantages.

First of all, in the present invention, after the mixture materials of kitchen waste and enzyme that may be used are poured into the container, the materials poured in are mixed, cut to small pieces and heated. Therefore, the speed for fermenting kitchen waste such as fruit and vegetable waste can be accelerated, resulting in reducing time and space occupied by accumulated materials as well as enhancing yield efficiency of organic fertilizer.

Secondly, in the present invention, the propelling blade assembly and the mixing blade assembly are sequentially arranged on the rotation shaft in the container, such that most part of the blended material can remain at the central position of the container after being mixed. Therefore, operations of operating staff can be made easier to enhance the effectiveness for material removal, and the probability for the operating staff to touch blade tools is decreased and so as to reduce operation dangers.

In conclusion, based on the disclosure of the present invention, it is able to achieve expected objects. More specifically, the present invention provides an organic fertilizer mixing device, which is capable of accelerating the speed for fermenting kitchen waste to enhance yield efficiency of organic fertilizer, providing easy way to enhance effectiveness for removing material, ensuring use safety, and being suitable for industrial application.

What is claimed is:

1. An organic fertilizer mixing device, comprising:
a container, having an top surface thereof formed as an opening, having therein a rotation shaft, two ends of the rotation shaft respectively positioned on a left support member and a right support member outside the container, one end of the rotation shaft connected to a driving member that drives the rotation shaft to rotate in its place in the container;
a propelling mixing blade assembly, connected to the rotation shaft in the container, for synchronously rotating with the rotation shaft; and
a heating unit, attached to most part of bottom of the container, for fully increasing a temperature at a inner side of the bottom portion of the container.

2. The organic fertilizer mixing device according to claim 1, wherein the rotation shaft rotates in its place in a direction from a top end of the container toward a front end of the container.

3. The organic fertilizer mixing device according to claim 2, wherein at least one material exit port is provided at a central position of the front end of the container, and at least one movable door is provided on the at least one material exit port for having the at least one material exit port covered or uncovered.

4. The organic fertilizer mixing device according to claim 2, wherein the propelling mixing blade assembly comprises a propelling blade assembly and a mixing blade assembly, for propelling and mixing material in the container.

5. The organic fertilizer mixing device according to claim 4, wherein the propelling blade assembly comprises:
a central propelling rod, having one end thereof connected axially to a central position of the rotation shaft, and having another end thereof provided with a central pushing portion;
a first left propelling rod, having one end thereof connected on the rotation shaft at the left side of and spaced from the central propelling rod in a direction away from the central propelling rod, and having another end provided with a first left pushing portion;
a second left propelling rod, having one end thereof connected on the rotation shaft at the left side of and spaced from the first left propelling rod in a direction away from the first left propelling rod, and having another end provided with at least one second left pushing portion;
a first right propelling rod, having one end thereof connected on the rotation shaft at the right side of and spaced from the central propelling rod in a direction away from the central propelling rod, and another end of the first right propelling rod provided with a first right pushing portion; and
a second right propelling rod, having one end thereof connected on the rotation shaft at the right side of and spaced from the first right propelling rod in a direction away from the first right propelling rod, and another end of the second right propelling rod provided with at least one second right pushing portions;
wherein the central propelling rod, the first left propelling rod, the second left propelling rod, the first right propelling rod and the second right propelling rod are respectively bent and extended outwardly from the rotation shaft in a direction reverse to a rotation direction of the rotation shaft.

6. The organic fertilizer mixing device according to claim 5, wherein the mixing blade assembly comprises:
a first left blade assembly, having a first left cutting blade and a second left cutting blade, one end of the first left cutting blade and one end of the second left cutting blade respectively connected on the rotation shaft between the central propelling rod and the first left propelling rod, another end of the first left cutting blade provided with a first left deflected portion deflecting leftward, and another end of the second left cutting blade provided with a second right deflected portion deflecting rightward;
a second left blade assembly, having a third left cutting blade and a fourth left cutting blade, one end of the third left cutting blade and one end of the fourth left cutting blade respectively connected on the rotation shaft between the first left propelling rod and the second left propelling rod, another end of the third left cutting blade provided with a third left deflected portion deflecting leftward, and another end of the fourth left cutting blade provided with a fourth right deflected portion deflecting rightward;
a fifth left cutting blade, having one end thereof connected on the rotation shaft, a connecting end of the second left propelling rod and the rotation shaft and the one end of the fifth left cutting blade forming an obtuse angle, and another end of the fifth left cutting blade provided with a fifth right deflected portion deflecting rightward;
a first right blade assembly, having a first right cutting blade and a second right cutting blade, one end of the first right cutting blade and one end of the second right cutting blade respectively connected on the rotation shaft between the central propelling rod and the first right propelling rod, another end of the first right cutting blade provided with a first left deflected portion deflecting leftward, and one other end of the second right cutting blade provided with a second right deflected portion deflecting rightward;
a second right blade assembly, having a third right cutting blade and a fourth right cutting blade, one end of the third right cutting blade and one end of the fourth right cutting blade respectively connected on the rotation shaft between the first right propelling rod and the second right propelling rod, another end of the third right cutting blade provided with a third left deflected portion deflecting leftward, and another end of the fourth right cutting blade provided with a fourth right deflected portion deflecting rightward; and
a fifth right cutting blade, having one end thereof connected on the rotation shaft, a connecting end of the second right propelling rod and the rotation shaft and the one end of the fifth right cutting blade forming an obtuse angle, and another end of the fifth right cutting blade provided with a fifth left deflected portion deflecting leftward;
wherein the first left cutting blade, the second left cutting blade, the third left cutting blade, the fourth left cutting blade, the fifth left cutting blade, the first right cutting blade, the second right cutting blade, the third right cutting blade, the fourth right cutting blade and the fifth right cutting blade are respectively bent and extended outwardly from the rotation shaft in a direction reverse to the rotation direction of the rotation shaft.

7. The organic fertilizer mixing device according to claim 1, wherein the heating unit is attached to the most part of the bottom portion of the container in a continuous winding way.

8. The organic fertilizer mixing device according to claim 1, wherein the heating unit has a plurality of heating plates, which are spaced from each other and attached in parallel to the most part of the bottom of the container.

9. The organic fertilizer mixing device according to claim 1, wherein the heating unit is electrically connected to a control unit for controlling a heating temperature of the heating unit.
